(19) United States
(12) Patent Application Publication
(10) Pub. No.: US 2026/0235399 A1
(43) Pub. Date: Aug. 13, 2026

(54) AUTOMATIC NON-CONTACT MEASUREMENT METHOD OF GOLF CLUBS

(71) Applicant: K.K. ENDO SEISAKUSHO, Niigata (JP)

(72) Inventors: Shohei GUNJI, Tokyo (JP); Junichi AMANO, Niigata (JP); Makoto OKADA, Niigata (JP); Takashi OCHIAI, Niigata (JP)

(73) Assignee: K.K. ENDO SEISAKUSHO, Niigata (JP)

(21) Appl. No.: 19/155,559

(22) PCT Filed: Jan. 30, 2024
(86) PCT No.: PCT/JP2024/002911

§ 371 Date: Aug. 12, 2025

(30) Foreign Application Priority Data
Feb. 13, 2023 (JP) 2023-019868

(51) Int. Cl. G01B 11/25; A63B 60/42; A63B 102/32; G06T 7/00; G06T 7/13; G06T 7/60

(52) U.S. Cl. CPC G01B 11/2518; A63B 60/42; G06T 7/0002; G06T 7/13; G06T 7/60; A63B 2102/32

(57) ABSTRACT

In an automatic non-contact measurement method of golf clubs, when the servo motor 20 is driven to rotate the main shaft, the movable basis 16 moves along the rail 15 (in the direction of x axis). A laser light irradiation devise 25 for irradiation with laser light and a digital camera 27 are disposed on the movable basis 16. The laser light irradiation devise 25 irradiates a shaft 6 of a golf club 5 with slit light 26 from an upper position of the shaft of the golf club. The digital camera takes, capturing the reflected light, takes an image of a semi ellipse arc shape and, from the shape, a center line of the shaft is calculated. Also score lines 11 are detected and a lie angle, a loft angle and a face progression are calculated to be acquired.

### TECHNICAL FIELD

The disclosure relates to an automatic non-contact measurement method of golf clubs and an equipment therefor, with which loft angles, lie angles, face progressions (FP), etc., of the golf clubs is measured in a non-contact manner.

In more detail, the disclosure relates to an automatic non-contact measurement method of golf clubs and an equipment therefor used in a course of producing golf clubs, with which loft angles, lie angles, face progressions (FP), etc., of the golf clubs can be measured in a short time and in a non-contact manner so as to enable deciding whether the golf clubs are produced as designed.

### BACKGROUND TECHNIQUES

It is important that a golf club holds dimensions, etc., as designed, as its loft angle, lie angle, FP, etc., have large influence on trajectory of a ball. Further, quality management of a golf club in a course of production is important and it is required to measure loft angles, lie angles, FP, etc., in a precise and quick manner. Measurement of these specifications are performed for every product by extremely skilled persons using measuring tools for measurement in a course of production, shipment, etc. On the other hand, methods for measuring angles automatically from images captured with a CCD camera have been presented conventionally in order to automate such measurement (see Patent Document 1). Also, an automated measuring equipment for performing measurement by irradiation with laser light as slit light (see Patent Document 2). Two digital cameras, laser slit light irradiation devises and two illuminating devises are used in this measuring equipment. Further, it is necessary to set center axis of the shaft of a golf club to be coincide with the optical axis of the digital cameras in a perpendicular plane during measurement.

### PRIOR ART DOCUMENTS

### Patent Documents

### patent Document 1

JP Published Patent Application No. H3-198876, A1

### Patent Document 2

JP Published Patent Application No. H10-337344, A1

### SUMMARY

### Problems to be Solved

With the measuring equipment disclosed in Patent Document 1, precise measurement of angle, etc., cannot be attained using an image of the CCD camera. Further, with the measuring equipment disclosed in Patent Document 2, two digital cameras, laser slit light irradiation devises and two illuminating devises are necessary, so that the measurement equipment becomes of a large scale. Additionally, as it is necessary to set center axis of the shaft of a golf club to be in a perpendicular plane during measurement, the operation of the measuring equipment requires skill and time, so that it is not suitable for use in production.

It is an object of the disclosure to present an automatic non-contact measurement method of golf clubs and an equipment therefor, with which also a person not skilled in the measurement can measure specifications of golf clubs.

It is another object of the disclosure to present an automatic non-contact measurement method of golf clubs and an equipment therefor, with which specifications of golf clubs can be measured using a simple equipment in a quick and precise manner.

### Means for Solving the Problems

The automatic non-contact measurement method of golf clubs according to the first aspect of the disclosure is an automatic non-contact measurement method of golf clubs using an automatic non-contact measuring equipment of golf clubs equipped with:
a laser light irradiation devise irradiating a golf club with laser light as slit light, and
a digital camera capturing reflected light of the irradiated laser light as an image; said method comprising:
a shaft holding step of placing a shaft of a golf club and holding the shaft,
an image capturing step of capturing an image of the shaft from appearance of the shaft,
a calculation step of a center line of the shaft of acquiring the centerline from the image of the shaft,
an image capturing step of a head of the golf club of capturing an image of the head of the golf club,
a calculation step of score lines of acquiring score lines from the image of the head of the golf club,
a calculation step of a standard face plane of acquiring a standard face plane from the image of the head of the golf club, and
a calculation step or steps of acquiring at least one of a lie angle, a loft angle and a face progression from the center line of the shaft, the score lines and the standard face plane.

The automatic non-contact measurement method of golf clubs according to the second aspect of the is characterized in that, in the first aspect of the disclosure, the image capturing step of capturing an image of the shaft and the image capturing step of a head of the golf club of capturing an image of the head of the golf club are executed by causing the laser light irradiation devise and the digital camera or the golf club to move in the direction of the center line of the shaft and by irradiating the shaft or the head to capture the image.

The automatic non-contact measurement method of golf clubs according to the third aspect of the disclosure is characterized in that, in the second aspect of the disclosure, the direction of irradiation of the laser light is one perpendicular to the center line of the shaft, and
the direction of image capturing with the digital camera is one having an angle to the direction of irradiation with the laser light.

The automatic non-contact measuring equipment of golf clubs according to the fourth aspect of the disclosure is an automatic non-contact measuring equipment of golf clubs equipped with:
a laser light irradiation devise irradiating a golf club with laser light as slit light,
a digital camera capturing reflected light of the irradiated laser light as an image,
a plurality of positioning blocks on which the shaft of the golf club is to be placed and held there, and
a relative movement means for causing either the laser light irradiation devise and the digital camera or the shaft to move relative to each other along the center line of the shaft.

The automatic non-contact measuring equipment of golf clubs according to the fifth aspect of the disclosure is characterized in that, in the fourth aspect, the relative movement means is composed as such that either the laser light irradiator and the digital camera or the shaft are/is placed on a movable basis, which is caused to move on a guide rail with feed screw driving.

The automatic non-contact measuring equipment of golf clubs according to the sixth aspect of the disclosure is characterized in that, in the fourth aspect, the laser light irradiation devise is placed to have such an angular position as to irradiate the shaft in the direction perpendicular to the center lone of the shaft, and
the digital camera is placed to have a direction of image capturing with an angle to the direction of irradiation with the laser light.

### Advantageous Effect of the Disclosure

The automatic non-contact measurement method of golf clubs and an equipment therefor according to the disclosure have an advantageous effect such that also an operator not skilled in the techniques can measure specifications of golf clubs and measurement of specifications of golf clubs can be conducted precisely and in a short time with a simple equipment.

### BRIEF DESCRIPTION OF DRAWINGS

FIG. 1 is an explanatory view generally showing principle of measurement with an automatic non-contact measuring equipment of a golf club in the first embodiment of the disclosure.

FIG. 2 are explanatory views for explaining principle of acquiring a position of a center line of a shaft from the external circular shape of the shaft, in which FIG. 2(a) is an example of photograph taken for slit light on the shaft, FIG. 2(b) is a view showing the center of the shaft calculated from the photograph, and FIG. 2(c) is an example of actual photograph taken for a shaft in a constant interval.

FIG. 3 are explanatory views showing a cross-sectional shape of the score lines when score lines are irradiated with slit light, in which FIG. 3(a) is an enlarged cross-sectional view and FIG. 3(b) is across-sectional view explaining the position of the score line.

FIG. 4 are views in which position of score lines are specified by measuring the score lines of the face of the golf club, in which FIG. 4(a) is a view depicting positions of measurement (black points) on the face and FIG. 4(b) is an explanatory view with a long score line as a standard.

FIG. 5 are explanatory views showing a method calculating a face as a standard, in which FIG. 5(a) is a view for a method of subdivision of measurement data employed as a standard and FIG. 5(b) is a view for explaining the face as a standard.

FIG. 6 is an explanatory view for explaining principle of measurement of FP.

FIG. 7 is a block diagram generally showing a control system for controlling the automatic non-contact measuring equipment of golf clubs.

FIG. 8 are explanatory views of specifications of a golf club, in which FIG. 8(a) is a front view and FIG. 8(b) is a left side view.

FIG. 9 is an explanatory view showing an appearance of an automatic non-contact measuring equipment of golf clubs in the second embodiment of the disclosure.

### DETAILED DESCRIPTION OF PREFERRED EMBODIMENTS

### First Embodiment

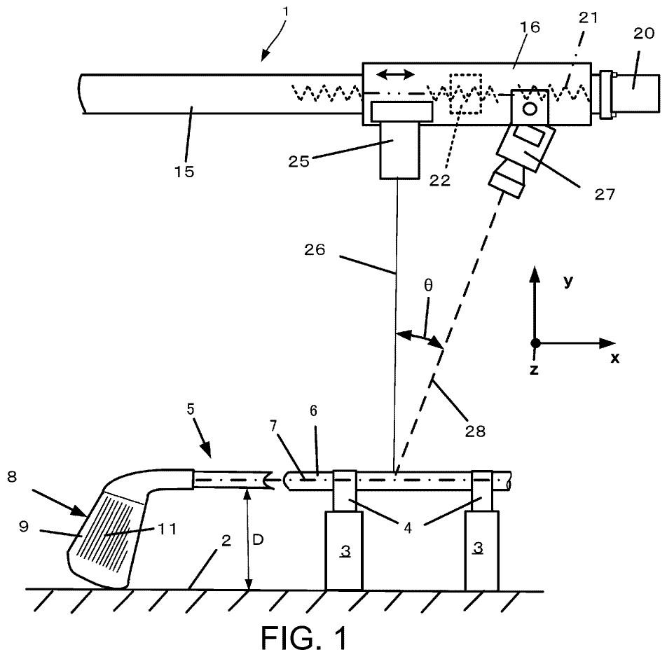

The automatic non-contact measuring equipment 1 of golf clubs according to the first embodiment of the disclosure will be explained below referring to drawings. FIG. 1 is an explanatory view generally showing principle of measurement with an automatic non-contact measuring equipment of a golf clubs. Two attaching blocks 3 are fixed on a main body 2 of the automatic non-contact measuring equipment 1 of golf clubs with a distance between them. A V-block 4 is fixed on each of the attaching blocks 3. The V-blocks 4 are common ones as cuboidal steel base bodies having groove of 90 degrees in this embodiment. The two V-blocks 4 are disposed to be fixed such that their V grooves are in a straight line and in a same plane. A cylindrical shaft 6 of a golf club 5 is placed on the two V-blocks 4 and the shaft 6 is held to be positioned with the V grooves. As the shaft 6 is placed on the V grooves, the center line 7 of the shaft is positioned at a decided position in widthwise direction of the V grooves at all time.

Further, as V-blocks 4 are attached on the main body 2 of the measuring equipment via the attaching blocks 3 fixed on the main body 2, the shaft 6 is placed thereon in a nearly horizontal direction with a distance D therefrom when it is placed on the V-blocks 4. Here, as the shaft 6 is not necessarily placed in a horizontal direction in a case where it is not of a cylindrical shape but of a tapered shape, “horizontal direction” in the disclosure denotes a concept including “nearly horizontal direction”. As the club head 8 at the tip of the shaft 6 is heavier than other portions, it sways around the center line 7 with its self-wight and is at a position lower than one where the shaft 6 is placed. The face 9 of the club head 8 is held with a predetermined angle in a stable situation without movement thereof. Consequently, as scattering of slit light 26 as laser light, with which the club head 8 is irradiated, is not easily created, it is possible to prevent scattering that interferes with measurement.

A rail 15 is fixedly disposed in parallel to the center line 7 at an upper position of the two V-blocks 4 in the main body 2 of the measuring equipment. A box shaped movable basis 16 is placed on the rail 15 to be move along freely with a linear bearing (not shown). A servo motor 20 is disposed at an end of the rail 15. A feed screw 21 as a ball screw is connected to the output shaft of the servo motor 20. The feed screw 21 is a screw for driving the movable basis 16 converting rotational movement to linear movement. A ball nut 22 engaged with the feed screw 21 is fixedly disposed in the movable basis 16. Consequently, when the servo motor 20 is driven to rotate the main shaft, the movable basis 16 moves along the rail 15 (in the direction of x axis). A laser light irradiation devise 25 for irradiation with laser light is positioned on the movable basis 16. This laser light irradiation devise 25 is one for outputting line-shaped laser light for measurement called slit light 26 in y axis direction. The center line of the shaft 6 is irradiated with slit light 26 from an upper position of the shaft 6 at a nearly right angle thereto. Here, for this nearly right angle, even if it is not a precise right angle, it can be corrected by calculation. Thus, “nearly right angle” in the disclosure denotes a concept including angles somewhat smaller or larger than the right angle.

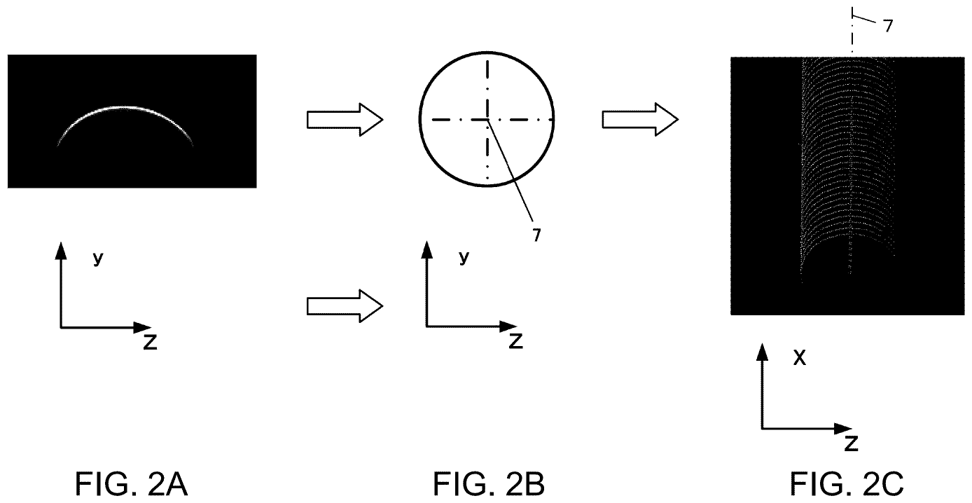

As the cylindrical shaft 6 is irradiated with slit light 26 from upper position in the direction perpendicular to the center line 7 of the shaft, its shape appears on the upper surface of the shaft 6 to be of a linear semi-circle. A digital camera 27 for taking this semi-circle shape is placed on the movable basis 16. The center line 28 as the optical axis of the digital camera 27 is set to be at an angular position with angle θ (acute angle) with the slit light 26. The center line of the slit light 26 from the laser light irradiation devise 25 and the center line 28 of the lens of the digital camera 27 move along the center line of the shaft 7. This movement is performed by driving the servo motor 20 to be rotated as well as causing both of the laser light irradiation devise 25 and the digital camera 27 placed on the movable basis 16 to move along the center line 7 of the shaft. The shaft 6 is irradiated with the slit light 26 having issued from the laser light irradiation devise 25 and the slit light 26 appears on the surface of the shaft 6 to be of a linear semi-circle. This irradiation light of a semi-circle shape is taken with the digital camera 27 in a direction of an angle θ with the slit light 26, so that the shape is taken as a semi-ellipse (precisely, arc of an ellipse) (see, FIG. 2(a)). Calculated from this semi-ellipse, position of the center line 7 of the shaft is acquired by a calculating method explained later.

### (Specifications of the Golf Club Head 8)

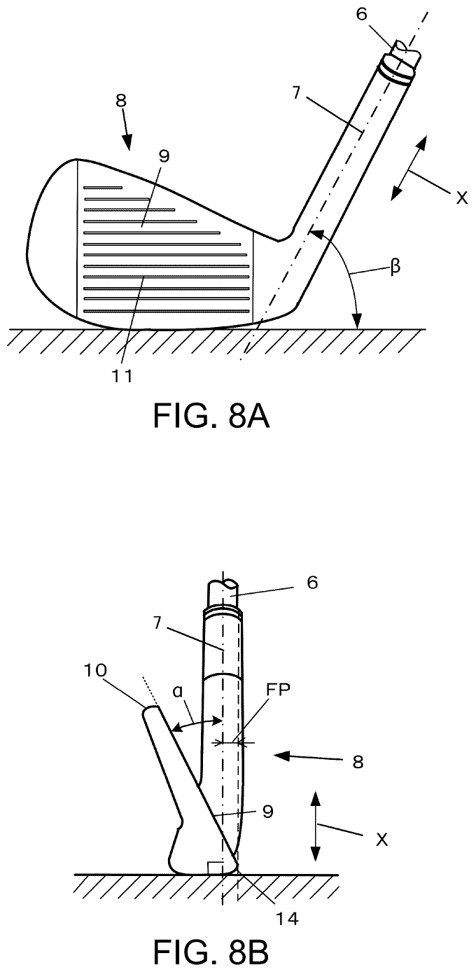

FIG. 8 are explanatory views of specification s of a golf club, in which FIG. 8(a) is a front view and FIG. 8(b) is a left side view. The lie angle β is an angle formed with the center line 7 of the shaft with the score lines 11. The loft angle α is an angle formed with the face 9 nearly as a plane of the club head 8 and a plane containing the center line 8 of the shaft (being also a plane parallel to the score lines 11). As whole of the face 9 on which score lines 11 are formed is not necessarily a plane, the face 9 in this embodiment is taken as of a plane measured and calculated by the method explained later. A shown in FIG. 8, the face progression (FP) is taken as a distance between a plane containing the center line 8 of the shaft (being also a plane parallel to the score lines 11) and a plane parallel to this plane and containing the tip end of the leading edge 14 (the most forward side of the face 9).

### (Measurement of the Center Line 7 of the Shaft)

Principle of configuration measurement, image processing and calculation processing with the automatic non-contact measuring equipment 1 of golf clubs explained above will be explained below. FIG. 2(a) to FIG. 2(c) are explanatory views explaining principle of acquiring a position of a center line of a shaft from the external circular shape of the shaft, in which FIG. 2(a) is an example of photograph taken for slit light on the shaft, FIG. 2(b) is a view showing the center of the shaft calculated from the photograph, and FIG. 2(c) is an example of actual photograph taken for a shaft in a constant interval. As the cylindrical shaft 6 is irradiated with the slit light 26 issuing from the laser light irradiation devise 25 from an upper position of the shaft 6 at a right angle with the center line 7 of the shaft, the shape in the photograph appears theoretically to be linear semi-circular one. The lower half of the shaft of 6 is in the blind spot for irradiation of the slit light 26, which does not appear here.

As the situation is taken from the position at an angle θ with the digital camera 27 (see FIG. 1), the taken image appears to be of a semi-ellipse shape as shown in FIG. 2(a). This semi-ellipse arc as two-dimensional data (pixels) is converted into three-dimensional data (space of x, y, z axes) in intervals of mm. This conversion of data is conducted based on the data of calibration having been conducted preliminarily. This calibration is one such as to geometrically correlate three-dimensional position (space of x, y, z axes) of outer diameter of the shaft 6 with two-dimensional data of the semi-ellipse arc as the taken image. A circle is acquired from this semi-ellipse shaped arc converted into three-dimension through least squares method and the center of this circle is taken as the center 7 of the shaft 6. Conducting this calculation plural times as determined in the lengthwise direction of the shaft 6 (see FIG. 2(c)), the center point of the circle is calculated. Then, acquiring a straight line (three-dimensional) through least squares method, the acquired is taken as the center line 7. With this, the vector and position of the center line 7 as the center of the shaft 6 of the golf club 5 is confirmed.

### (Measurement of the Score Line 11)

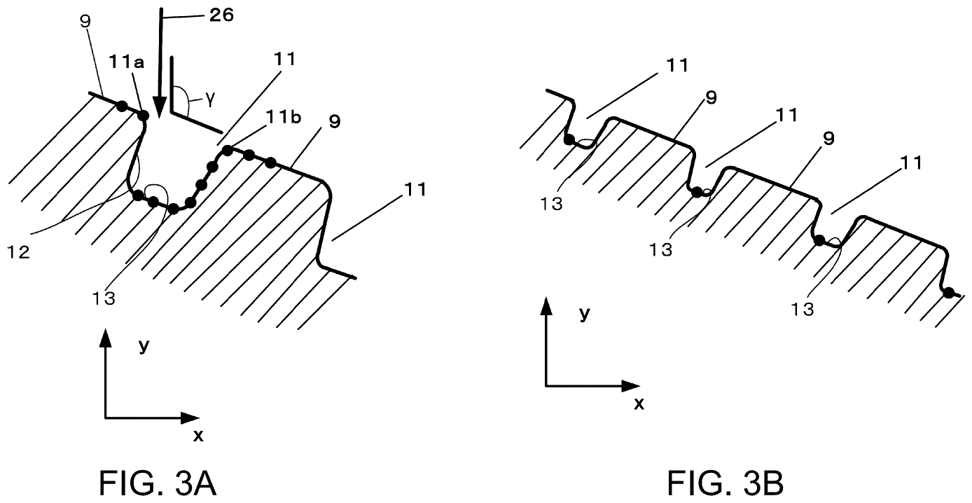

Score lines 11 formed on the face 9 are variously defined in R&A, etc., as “Specifications of Grooves”. As defined, an edge of a groove must have a substantially circular cross-sectional shape and also dimension of its effective radius is defined there. FIG. 3 are explanatory views showing a cross-sectional shape of the score lines when the score line is irradiated with slit light, in which FIG. 3(a) is an enlarged cross-sectional view and FIG. 3(b) is a cross-sectional view explaining the position of the score line. As shown in FIG. 3(a), the score lines 11 on the face 9 placed at an angle γ with the slit light 26 is irradiated with the slit light 26 continuously. At this time, each position (position in three-dimensional space) as each measurement point is specified from reflected light of the slit light 26.

As shown in FIG. 3(a), while neighboring measurement points on the face 9 (dark spots as shown) on the face 9 at this time are specified to be continuous as each two of them are near to each other, the side wall 12 of the score line 11 is in a blind spot, so that the slit light is not reflected at the side wall 12 but reflected at the bottom of the groove 13. That is, causing the slit light 26 to move in x-direction (FIG. 3) as well as to irradiate the face 9, the reflected light is measured at a determined interval. When the slit light 26 comes to a position of the score line 11, it is reflected not at the side wall 12 but at the bottom of the groove 13. For measurement value at this time, a step of measurement value appears corresponding to the step (in y-direction), thus the position where such step is measured (dark spots as shown) is decided to be the position of the bottom of the groove 13 of the score line 11 (FIG. 3(b)). Such measurement is conducted over the whole surface of the face 9. The standard for deciding the measured position as the position of the step is such as to decide it according to dimension of such step (in y-direction). This dimension of the step is decided in such a manner as, setting values from dimension and tolerance decided in designing, to decide it using differential values, threshold values, measurement data of actual products, etc.

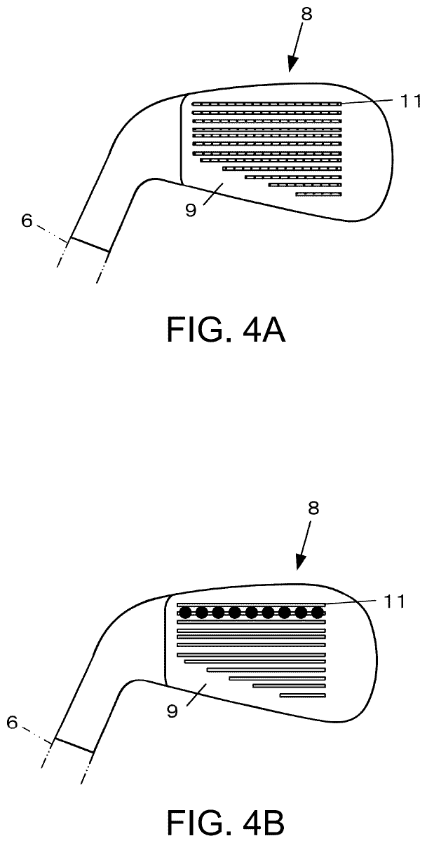

FIG. 4 are views in which position of score lines are decided by measuring the face of the golf club with the above detecting method of the score line 11, in which FIG. 4(a) is a view depicting decided positions (black points) on the face and FIG. 4(b) is an explanatory view with a long score line as a standard. Each dot (dark point) is on the score line specified through the above algorithm. The score line 11 is formed to be a plurality of parallel grooves and is detected as an image of depicted dots shown in FIG. 4(a). A straight line is acquired using each of these dots (dark points) through least squares method and the acquired straight line is taken as the score line 11. At this time, only long straight lines are employed as the score line among the straight lines. In this, as measured lengths of the score lines 11, being different from a designed value, are not necessarily same, an averaged value of vectors of a plurality of score lines 11 is taken as an inclination of the score lined 11 here. Further, coordinates (position on x, y, z axes) of both ends of the straight line as calculated to be longest are taken as both ends of the score line 11.

### (Calculation of Loft Angle α)

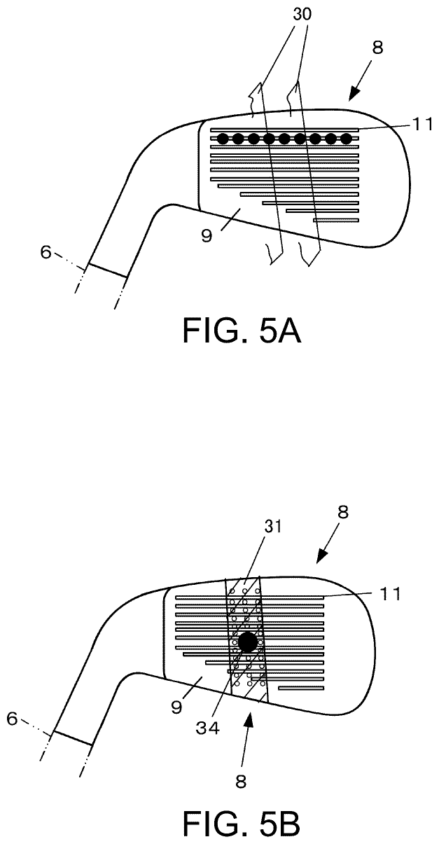

As shown in FIG. 5, the center position of this averaged score line 11 in the lengthwise direction thereof is acquired and, around this center position, the face 9 is partitioned with two partitioning planes 30 perpendicular to the score lines 11 and having a decided distance between them (see FIG. 5(a)). In other words, the score lines 11 are said to be a normal vector plane to the partitioning planes 30. Then, a belt-shaped standard face plane 31 is decided by a method explained later (see FIG. 5(b)). A group of dots alone, for which shape change amount is decided to be less than a predetermined threshold value according to its differential value, etc., are extracted. With this, upper and lower curved surfaces of the face 9, irregularities withing the score lines 11, etc., can be excluded. A plane is calculated from the extracted group of dots through least squares method to be a standard face plane 31. When the standard face plane 31 is confirmed, the above explained loft angle α formed with the center line 12 of the shaft can be calculated to be confirmed.

### (Measurement of Face Progression (FP))

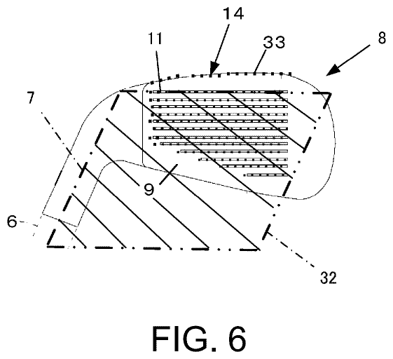

As explained referring to FIG. 8(b), face progression (FP) is a value (distance) denoting by what a distance the leading edge 14 of the club head 8 is apart from the center line 7 of the shaft. FIG. 6 is an explanatory view for explaining principle of measurement of FP. A center line plane 32 of the shaft containing the center line 7 of the shaft is defined with a plane parallel to the above explained score line 11. Normal line distance of each measurement point 33 of the measured leading edge 14 from the center line plane 32 of the shaft is calculated. The measurement point most distant from the respective measurement points 33 is taken as FP point providing the face progression (FP) (see FIG. 8).

### (Controlling System 40 of the Automatic Non-Contact Measuring Equipment of Golf Clubs)

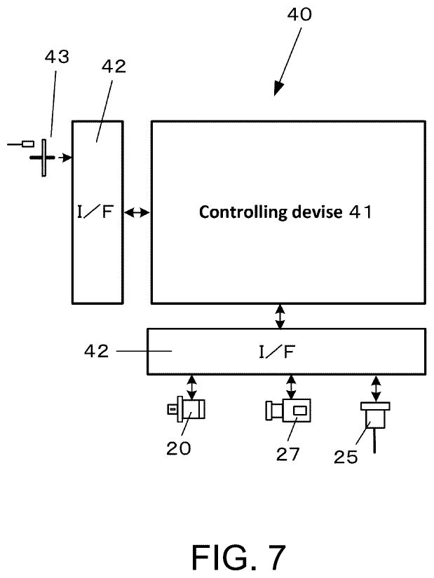

FIG. 7 is a block diagram generally showing a control system 40 for controlling the automatic non-contact measuring equipment 1 of golf clubs. The controlling devise 41 of the control system 40 is a known sequence controlling means consisting of CPU (central processing unit), RAM, ROM, auxiliary storing unit, display means, entry means, various output means, etc. Position signal is sent from a position detecting sensor 43 to the controlling devise 41 via an interface (I/F) 42. The position detecting sensor 43 is one for detecting a position of the movable basis 16 in x-axis direction. Specifically, it is a rotary encoder detecting rotation of a servomotor 20. Further, the servo motor 20, the laser irradiation devise 25 and the digital camera 27 are connected via another interface (1/F) 42 to the control devise 41, which controls ON, OFF, etc., of these. With the controlling devise 41, the above explained image processing and calculation processing are conducted by software stored in CPU (central processing unit), RAM, auxiliary storing devise, etc. Such specific processing is of known techniques, so explanation thereof is omitted here.

### Second Embodiment

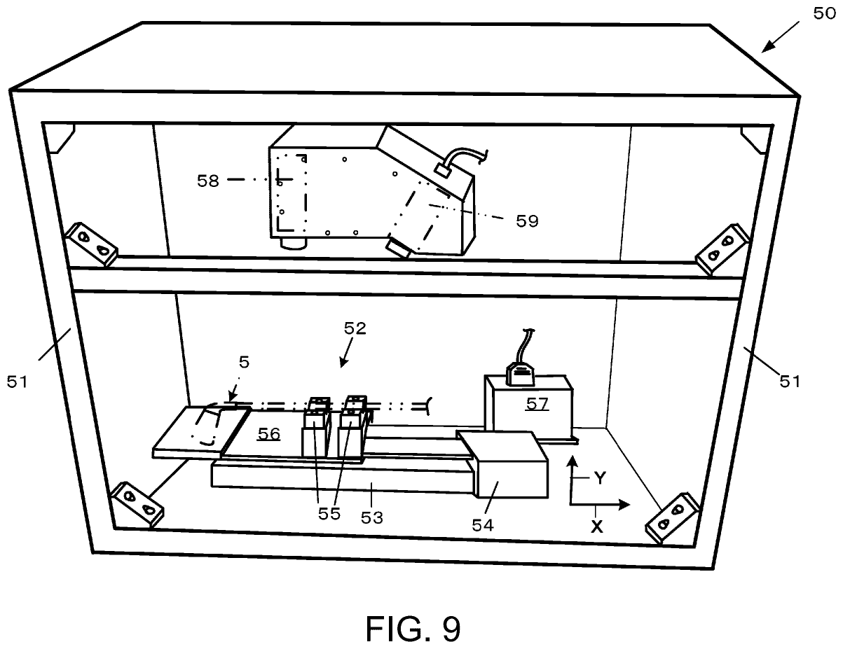

With the automatic non-contact measuring equipment 1 of golf clubs in the first embodiment of the disclosure, the laser light irradiation devise 25 and the digital camera 27 are placed on the movable basis 16, which is driven with a screw to move along the guide rail 15. Alternately, such a method may also be employed that the golf club 5 is caused to move with the laser light irradiation devise 25 and the digital camera 27 fixed thereto. FIG. 9 is a view showing an appearance of an automatic non-contact measuring equipment 50 of golf clubs in the second embodiment of the disclosure. The automatic non-contact measuring equipment 50 of golf clubs is of an example of structure, in which a golf club is caused to move. A main body 51 as a cabinet of the measuring equipment is a cuboid shaped box with cavity space therein and an opening in the front side face. Due to this, the structure of the main body prevents light, dusts, etc., impeding measurement from entering therein when measurement is conducted as well as allows it easy to place or take off the golf club through the front face side of the main body 51. An automatic stage mechanism as a unit for causing a golf club 5 to move is disposed on the bottom plate of the main body 51 of the measuring equipment. The automatic stage mechanism 52 composed as a unit and containing a movement control devise thereof is known and commercially available. A rail (not shown) is disposed to be fixed on the basis 53 and movable basis 56 is placed on the rail in a movable manner with a linear bearing (not shown).

Two V-blocks 55 are placed to be fixed on the movable basis 56. A servo motor 54 is disposed at an end of the rail. A feed screw (not shown) as a ball screw is connected to the output shaft of the servo motor 54. The feed screw is a screw for driving the movable basis 56 by converting rotational movement to linear movement. A ball nut (not shown) engaged with the feed screw is fixedly disposed in the movable basis 56. Consequently, when the servo motor 54 is driven to rotate the main shaft, the movable basis 56 moves along the rail (in the direction of x axis). A laser light irradiation devise 58 for irradiating the golf club with laser light and a digital camera 59 are disposed to be fixed on the main body 51 above the automatic stage mechanism 52. The laser light irradiation devise 58 and the digital camera 59 have similar composition and function as the laser light irradiation 25 and the digital camera 27 in the first embodiment, so explanation thereof is omitted here. A control devise 57 for controlling the automatic stage mechanism 51, the laser light irradiation devise 58 and the digital camera 59 are disposed on the main body 51 of the measuring equipment. The automatic non-contact measuring equipment 50 of golf clubs in the second embodiment is preferable for use in measurement of a golf club having a long shaft. Here, while a screw is used as a feed screw for driving the movable basis 56 in the above explanation, another composition with two movable stages may be employed in which another movable basis is placed on the movable basis 56 and the placed movable basis is also equipped with a feed screw.

### Other Embodiments

The score line 11 explained above, precisely the basic face plane 31 is decided with a position of the bottom of the groove 13. As another manner of decision, the score line may be decided with a position of an angular portion 11b of the score line 11, as shown in FIG. 3(a). In such a manner of decision, detection can be conducted with a pair of angular portions on both sides of the bottom 13 of the groove with the other angular portion 11a, so that there is an advantage of precise detection. That is, precise detection can be conducted advantageously, as score line can be decided with a differential value in y-axis direction of the angular portion 11a and a differential value of side wall 12 of angular portion 11b as well as a measurement value of the score line 11. While the standard face 31 explained above is of a belt-shape, the standard face plane 31 may be of a circular shape containing the sweet spot 34 (see FIG. 5(b)). Also, as explained above, the lie angle β is an angle formed with the center line 7 of the shaft and the ground contact surface when the golf club is placed with the score line 11 being parallel to the ground contact surface and the plane containing the center line 7 of the shaft being perpendicular to the ground contact surface. Consequently, as position of the center line 7 of the shaft and the score line 11 can be measured, the lie angle can be measured.

The direction of taking with the digital camera 27 forms an angle θ with the direction of irradiation with the slit light 26, in the above explanation. This angle θ may be of any degrees as long as scattering, etc., does not occur. Similarly, the laser light irradiation devise 25 irradiates the shaft with the slit light 26 in a direction perpendicular to the center line 7 of the shaft in the above explanation. Here, irradiation may be done at any degrees as long as scattering, etc., does not occur. Furthermore, while the automatic non-contact measuring equipment 1 of golf clubs has been explained assuming mainly measurement in production step of golf clubs, it may be used in a golf course, a golf driving range, a golf equipment shop, etc., for used golf clubs or golf clubs on sale.

### EXPLANATION OF MARKS

1, 50 non-contact measuring equipment of golf clubs
2, 51 main body of measuring equipment
3 attaching block
4, 55 V-block
5 golf club
6 shaft
7 center line of shaft
8 club head
9 face
11 score line (face line)
12 side face
13 bottom of groove
14 leading edge
15 rail
16, 56 movable basis
20, 54 servo motor
21 feed screw
22 ball nut
25, 58 laser light irradiation devise
26 slit light
27, 59 digital camera
30 partitioning plane
31 standard face
32 center line plane
33 measurement point (leading edge)
34 sweet spot
52 automatic stage mechanism
α loft angle
β lie angle
γ angle of face with slit light

1. An automatic non-contact measurement method of golf clubs, using an automatic non-contact measuring equipment of golf clubs equipped with:
a laser light irradiation devise irradiating a golf club with laser light as slit light, and
a digital camera capturing reflected light of the irradiated laser light as an image;
said automatic non-contact measurement method comprising:
a shaft holding step of placing a shaft of a golf club and holding the shaft,
an image capturing step of capturing an image of the shaft from appearance of the shaft,
a calculation step of a center line of the shaft of acquiring the centerline from the image of the shaft,
an image capturing step of a head of the golf club of capturing an image of the head of the golf club,
a calculation step of score lines of acquiring score lines from the image of the head of the golf club,
a calculation step of a standard face plane of acquiring a standard face plane from the image of the head of the golf club, and
a calculation step or steps of acquiring at least selected one of a lie angle, a loft angle and a face progression from the center line of the shaft, the score lines and the standard face plane.

2. The automatic non-contact measurement method of golf clubs according to claim 1,
wherein the image capturing step of capturing an image of the shaft and the image capturing step of a head of the golf club of capturing an image of the head of the golf club are executed by causing the laser light irradiation devise and the digital camera or the golf club to move in the direction of the center line of the shaft and by irradiating the shaft or the head to capture the image.

3. The automatic non-contact measurement method of golf clubs according to claim 2,
wherein the direction of irradiation of the laser light is one perpendicular to the center line of the shaft, and
the direction of image capturing with the digital camera is one having an angle to the direction of irradiation with the laser light.

4. (canceled)

5. (canceled)

6. (canceled)
